(19) United States
(12) Patent Application Publication
(10) Pub. No.: US 2010/0167965 A1
(43) Pub. Date: Jul. 1, 2010

(54) Amphiphobic Proppant

(75) Inventors: Herbert M. Sebastian, Cypress, TX (US); Mark D. Glover, Katy, TX (US); Philip S. Smith, Houston, TX (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/641,120

(22) Filed: Dec. 17, 2009

Related U.S. Application Data
(60) Provisional application No. 61/140,898, filed on Dec. 26, 2008.

(51) Int. Cl. C09K 8/80

(52) U.S. Cl. 507/230; 507/200; 507/204; 507/205; 507/219; 507/233; 507/234; 507/266; 507/269

(57) ABSTRACT

Methods and compositions for forming a hydraulic fracture are disclosed herein. The methods and compositions make use of novel amphiphobic proppants. The amphiphobic properties of the disclosed proppant compositions provide several advantages over existing solutions. The hydrophobic nature of the proppant enhances recovery of fracture fluid from the fracture as well as prevents liquid build-up with the fracture. Additionally, the lipophobic nature of the proppant may enhance production of hydrocarbons from the fracture.

### CROSS-REFERENCE TO RELATED APPLICATIONS

This application claims the benefit of U.S. Provisional Application No. 61/140,898, filed Dec. 26, 2008, which is hereby incorporated by reference in its entirety for all purposes.

### STATEMENT REGARDING FEDERALLY SPONSORED RESEARCH OR DEVELOPMENT

Not applicable.

### BACKGROUND

### Field of the Invention

This invention relates generally to the field of oil and gas well treatments. More specifically, the invention relates to a method and compositions for hydraulic fracturing of subterranean formations.

### BACKGROUND OF THE INVENTION

Hydraulic fracturing is a method used to create fractures that extend from a borehole into rock formations, which are typically maintained by a proppant. The technique is used to increase or restore the rate which fluids, such as oil, gas or water, can be produced from an underground formation. When applied to stimulation of water injection wells, or oil/gas wells, the objective of hydraulic fracturing is to increase the amount of exposure a well has to the surrounding formation and to provide a conductive channel through which the fluid can flow easily to the well. A fracture is formed by pumping a fracturing fluid into the well bore at a rate sufficient to increase the pressure downhole to a value in excess of the fracture gradient of the formation rock. The pressure then causes the formation to crack which allows the fracturing fluid to enter and extend the crack further into the formation.

In order to keep this fracture open after the injection stops, a solid proppant is added to the fracture fluid. The proppant, which is commonly a sieved particulate solid (e.g. sand), is carried into the fracture. The proppant is chosen to be higher in permeability than the surrounding formation and the propped hydraulic fracture then becomes a high permeability conduit through which the formation fluids can be produced back to the well. The fracture fluid can be any number of fluids, ranging from water to gels, foams, nitrogen, carbon dioxide or even air in some cases. Various types of proppant are used, including sand, resin-coated sand, man-made ceramics, and plastics depending on the type of permeability or grain strength needed.

One problem with hydraulic fracturing is removal or recovery of fracture fluid from the hydraulic fracture. Fracturing fluids which remain in the hydraulic fracture after completion of the fracturing job are detrimental to the performance of hydraulically fractured wells by reducing the conductivity of the hydraulic fracture. During production of the well, liquid, water, or hydrocarbons may build up in the hydraulic fracture. This build-up reduces permeability of gas and/or oil through the fracture (e.g. conductivity) and negatively impact productivity.

Consequently, there is a need for improved methods and compositions for forming a hydraulic fracture to alleviate the above described problems.

### BRIEF SUMMARY

Methods and compositions for hydraulic fracturing a subterranean formation are disclosed herein. The methods and compositions make use of novel amphiphobic proppants. The amphiphobic properties of the disclosed proppant compositions provide several advantages over existing solutions. The hydrophobic nature of the proppant may enhance recovery of fracture fluid from the fracture as well as prevent liquid build-up within the fracture. Additionally, the lipophobic nature of the proppant may enhance production of hydrocarbons from the fracture. Further features and details of embodiments of the method and compositions will be described in more detail below.

In an embodiment, a method of fracturing a subterranean formation comprises coating a plurality of particles with an amphiphobic coating to form amphiphobic proppants. The method also comprises mixing the amphiphobic proppants with a carrier fluid to form a slurry and introducing the slurry into a fracture in the subterranean formation to prevent build-up of fluid within the fracture and also enhance production of hydrocarbons from the fracture.

In another embodiment, a method of fracturing a subterranean formation comprises providing amphiphobic proppants made from one or more amphiphobic compounds. The method further comprises mixing the amphiphobic proppants with a carrier fluid to form a slurry and introducing the slurry into the subterranean formation to open a fracture. The amphiphobic proppants prevent build-up of fluid within the fracture and also enhance production of hydrocarbons with the fracture.

In an embodiment, a proppant comprises a particulate substrate material and an amphiphobic coating at least partially covering the particulate substrate material.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the concept and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection whether it be mechanical, chemical, or electrical coupling. Thus, if a first element couples to a second element, that connection may be through a direct connection, or through an indirect connection via other elements and connections.

As used herein, the term “amphiphobic” refers to coatings or compounds which are repellant to both oil and water (e.g. hydrophobic and lipophobic). The terms “lyophobic” and “hydrophobic-lipophobic” may also be used synonymously with amphiphobic. Thus, an amphiphobic compound generally does not exhibit affinity either to lipophilic substances or to hydrophilic substances, or to a mixture of hydrophilic and lipophilic materials.

As used herein, the term “amphiphobic proppant” may refer to proppants treated with an amphiphobic compound or a proppant which is made from an amphiphobic compound or material.

As used herein, the term “hydrophobic” refers to coatings or compounds which are repellant to water.

As used herein, the terms “lipophobic” or “oleophobic” may be used interchangeably to refer to coatings or compounds which are repellant to oil.

### DETAILED DESCRIPTION OF THE PREFERRED EMBODIMENTS

Generally, an embodiment of a method of fracturing a subterranean formation comprises treating a proppant with an amphiphobic compound or coating. Without being limited by theory, by coating the proppant with an amphiphobic coating or compound, making the proppant oil repellant and water repellant, the conductivity of the proppant may be effectively increased, thereby increasing production in the fracture. The water repellant properties of the amphiphobic coating facilitates removal of fracture fluid from the fracture and also prevents build-up of water in the hydraulic fracture. The oil repellent properties prevents build-up of liquid hydrocarbons in the hydraulic fracture.

In an alternative embodiment, the method may comprise using a proppant made from a compound which is inherently amphiphobic. In other words, the proppant need not be coated because it is made from a material which already possesses amphiphobic properties.

Preferably, the proppant may be pre-treated so as to form an amphiphobic coating on the proppant. As used herein, the term “pre-treated” refers to treating the proppant before it is mixed with the fracture fluid for deposition into the fracture. The proppant may be “pre-treated” at a factory or manufacturing site before arrival at the well site or the proppant may be treated in situ or at the well site. Alternatively, proppant may be treated by flowing a stream comprising particulates continuously into another flowing stream comprising the one or more amphiphobic coating agents so that the streams are combined and mixed while continuing to flow as a single stream as part of the on-going treatment at the well site. Such treatments may be described as “real-time” mixing. One such in situ method would involve continuously conveying the particulates and the one or more amphiphobic coating agents to a mixing vessel, for example, using a sand screw. Once inside the mixing vessel, the particulates would be contacted with the amphiphobic coating agent and continuously removed from the mixing vessel. In that situation, the sand screw could be used both to aid in mixing the particulates, be they gravel, proppant, or some other particulates, with the one or more amphiphobic coating agents and to remove the one or more amphiphobic coating agents from the mixing tank. As is well understood in the art, batch or partial batch mixing may also be used to accomplish such coating at a well site just prior to introducing the particulates into a subterranean formation.

As explained above, the amphiphobic compounds or coating agents impart the unique property of being both water and oil repellant to the proppant. Any suitable compounds may be used to treat the proppant or used as the proppant so as to make the proppant amphiphobic. Specifically, examples of compounds or coatings include without limitation, silicon dioxide solvated in ethanol or other solvents, organo-siloxanes, fluoropolymers, fluorinated compounds, tetrafluoroethylene/(perfluoroalkyl) vinyl ether copolymer (PFA), perfluoroalkyl phosphates, perfluoroalkyl ethyl methacrylates, fluorinated hydrocarbons, polyfluoroalkylethyl methacrylate/alkylmethacrylate copolymer, perfluoroalcohol phosphate, perfluoroalcohol phosphate/polysiloxane mixture, perfluoroalcohol phosphate/acrylate silicone copolymer mixture, tetrafluoroethylene/ hexafluoropropylene copolymer (FEP), polytetrafluoroethylene (Teflon), polyxylene (Parylene), fluorinated polyhedral oligomeric silsequioxanes, or combinations thereof. In further embodiments, the amphiphobic compound may include without limitation, fluorosilanes, fluorosiloxanes, fluoroalkylsilanes, fluorosilazane, or combinations thereof. The fluorosilane may include without limitation, perfluoroalkylsilanes, fluorosilanes having an urethane linkage, fluorosilanes having its silicone part partially modified with fluorine or fluoride, etc. Examples of fluorinated alkylsilanes are described in U.S. Pat. Nos. 5,571,622; 5,324,566; and 5,571,622 which are hereby incorporated by reference in their entirety for all purposes.

In another embodiment, the amphiphobic coating may comprise a diamond-like carbon (DLC) coating and combinations of Ti, Co and Zr with one of N, C, 0 and P.

In yet another embodiment, the amphiphobic coating may comprise more than one compound. More specifically, the amphiphobic coating may include a combination of a hydrophobic compound and a lipophobic compound. For example, the proppant may be coated with a hydrophobic compound to impart hydrophobicity and then coated with a lipophobic compound to impart lipophobicity. Alternatively, the hydrophobic compound and the lipophobic compound may be mixed together and then applied to the proppant. Any suitable hydrophobic and lipophobic compounds may be used.

Any suitable proppant may be coated or treated with the amphiphobic compound. The proppant may serve as a substrate for the amphiphobic coating. The proppant may be partially or completely coated with the amphiphobic compound.

In embodiments, the proppant typically comprises particulate solids. Examples of suitable proppants include without limitation, sand, bauxite, sintered bauxite, silica alumina, glass beads, ceramic materials, glass materials, polymer materials, polytetrafluoroethylene materials, nut shell pieces, seed shell pieces, fruit pit pieces, wood, composite particulates, gravel, or combinations thereof. Generally, the particulate solids may have a particle size in the range of from about 2 to about 400 mesh, U.S. Sieve Series. In particular, the proppant may have a particle size in the range of from about 10 mesh to about 70 mesh, U.S. Sieve Series. More particularly, the particle size distribution ranges of the proppant may be about 10 to about 20 mesh, 20 to 40 mesh, 40 to 60 mesh or 50 to 70 mesh, depending on the particular size and distribution of formation solids to be screened out by the particulate solid pack. Although the proppant may be of any shape, the proppant generally may be spherical. However, proppants with other particulate solid shapes may also be utilized such as without limitation, ellipsoidal, platelet-shaped, toroidal, oblate spheroids, prolate spheroids, scalene spheroids, rod-like, or combinations thereof.

The amphiphobic proppant may be mixed with a carrier fluid before deposition into the hydraulic fracture. The carrier fluid may be any existing fracture fluid as is known to those of skill in the art. A variety of carrier liquids can be utilized including without limitation, aqueous gels, foams or emulsions. The foams may be comprised of water, one or more foaming agents and a gas such as nitrogen or air. The emulsions may be comprised of water and a liquefied, normally gaseous fluid such as carbon dioxide. Upon pressure release, the liquefied gaseous fluid in an emulsion vaporizes and rapidly flows out of the treated formation.

Alternatively, the carrier liquid is an aqueous gel comprised of water, an agent for gelling the water and increasing its viscosity, and optionally, a cross-linking agent for cross-linking the gel and further increasing the viscosity of the liquid. The increased viscosity of the gelled or gelled and cross-linked liquid reduces fluid loss and allows the liquid to transport significant quantities of suspended particulate solids.

A variety of gelling agents can be utilized including hydratable polymers which contain one or more of the functional groups such as hydroxyl, cis-hydroxyl, carboxyl, sulfate, sulfonate, amino or amide. Particularly useful such polymers are polysaccharides and derivatives thereof which contain one or more of the monosaccharide units galactose, mannose, glucoside, glucose, xylose, arabinose, fructose, glucuronic acid or pyranosyl sulfate. Natural hydratable polymers containing the foregoing functional groups and units include guar gum and derivatives thereof, locust bean gum, tara, konjak, tamarind, starch, cellulose and derivatives thereof, karaya, xanthan, tragacanth and carrageenan. Hydratable synthetic polymers and copolymers which contain the above mentioned functional groups and which have been utilized heretofore include polyacrylate, polymethacrylate, polyacrylamide, maleic anhydride, methylvinyl ether polymers, polyvinyl alcohol and polyvinylpyrrolidone.

Examples of crosslinking agents which can be utilized to further increase the viscosity of the gelled fracturing fluid are multivalent metal salts or other compounds which are capable of releasing multivalent metal ions in an aqueous solution. Examples of the multivalent metal ions are chromium, zirconium, antimony, titanium, iron (ferrous or ferric), zinc or aluminum. The above described gelled or gelled and crosslinked fracturing fluid can also include gel breakers such as those of the enzyme type, the oxidizing type or the acid buffer type which are well known to those skilled in the art. The gel breakers cause the viscous fracturing fluids to revert to thin fluids that can be produced back to the surface after they have been used to create and prop fractures in a subterranean zone.

The concentration of proppant in the carrier fluid may be any concentration known in the art. Specifically, the proppant concentration may be in the range of from about 0.01 to about 1.75 kilograms of proppant added per liter of composition, alternatively from about 0.02 to about 1.5 kilograms of proppant added per liter of composition, and alternatively from about 0.05 to about 1.25 kilograms of proppant added per liter of composition.

Any suitable method may be used to apply the amphiphobic coating to the proppant. In on embodiment, the coating may be applied by mixing the proppant and the coating for a specific amount of time, then drying the coated proppant. Other methods for applying a coating include, but are not limited to, other “submerging” processes, spinning, dipping, plasma surface enhancement, chemical vapor deposition, spin coating, immersion, or alternatively, spraying, and mixing in mixers, mullers, or combinations thereof. One specific example of a plasma surface treating coating method is described in U.S. patent application Ser. No. 10/593,207, incorporated herein by reference in its entirety for all purposes.

The hydrophobicity (water repellency) and lipophobicity (oil repellency) of embodiments of the amphiphobic proppants, whether pre-treated or not, may be determined by a number of techniques. The hydrophobicity and lipophobicity of the present inventive composition have reference to the composition in a dry form (and preferably in a flat form for testing purposes), as opposed to a liquid form, such as when the present inventive composition is in the form of a dispersion (which can be tested after a product is formed from the dispersion and the carrier liquid is evaporated).

Hydrophobicity in the context of the present invention can be described in terms of the resistance to liquid penetration. The amphiphobic proppant desirably has a water repellency value as measured by contact angle of about 90° or more, alternatively about 130° or more, alternatively about 150° or more.

Lipophobicity in the context of the present invention can be described in terms of the resistance to liquid penetration in the same manner as described above for hydrophobicity, except using liquids other than water. For example, embodiments of the amphiphobic proppant may have a mineral oil repellency value as measured by contact angle of about 90° or more, alternatively about 120° or more, alternatively about 150° or more. Similarly, the amphiphobic proppant may have an isopropyl alcohol (70% conc.) repellency value as measured by contact angle of about 90° or more, alternatively about 130° or more, alternatively about 150° or more.

Lipophobicity in the context of the present invention also can be described in terms of a drop of mineral oil or another suitable aliphatic liquid not being able to wet the surface of a product of the present invention when such a drop is placed in contact with the product. Embodiments of the amphiphobic proppant may be so oleophobic that a drop of mineral oil does not wet the surface of the proppant.

In an embodiment, the pre-treated amphiphobic proppant is part of methods of fracturing a subterranean formation, the methods including injecting a hydraulic fluid into a subterranean formation at a rate and pressure sufficient to open a fracture therein, and injecting into the fracture a fluid containing a proppant having an amphiphobic coating. Techniques for hydraulically fracturing a subterranean formation are known to persons of ordinary skill in the art, and will involve pumping the fracturing fluid into the borehole and out into the surrounding formation. The fluid pressure is above the minimum in situ rock stress, thus creating or extending fractures in the formation.

In most cases, a hydraulic fracturing consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, the amphiphobic proppants may be added to the fluid to form a slurry that is pumped into the fracture to prevent it from closing when the pumping pressure is released. The proppant suspension and transport ability of the treatment base fluid traditionally depends on the type of viscosifying agent added.

When used in fracturing operations, the amphiphobic proppant may be applied as the sole proppant in a 100% proppant pack (in the hydraulic fracture) or as a part replacement of existing commercial available ceramic and/or sand-based proppants, resin-coated and/or uncoated, or as blends between those of the proppant injected into the well. The amphiphobic proppants may also be employed as the sole media in a 100% filtration pack or blended with other filtration media. Also, the amphiphobic proppant may be used as “blends” where the coated proppants are thoroughly and intimately mixed with conventional or other proppants, or the proppant may be used as “tail-ins” where the coated proppant is “tailed in” at the end of a treatment (to protect the most susceptible near-wellbore region from scale), or even, the proppant may be used in specific placement techniques, where the proppant may be layered in a fracture by depositional or slickwater methods.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of fracturing a subterranean formation comprising:
a) coating a plurality of particles with an amphiphobic coating to form amphiphobic proppants;
b) mixing the amphiphobic proppants with a carrier fluid to form a slurry; and
c) introducing the slurry into a fracture in the subterranean formation to prevent build-up of fluid within the fracture and also enhance production of hydrocarbons from the fracture.

2. The method of claim 1 wherein the amphiphobic coating comprises silicon dioxide solvated in ethanol or other solvents, organo-siloxanes, fluoropolymers, fluorinated compounds, tetrafluoroethylene/(perfluoroalkyl) vinyl ether copolymer (PFA), polyfluoroalkylethyl methacrylate/alkylmethacrylate copolymer, perfluoroalcohol phosphate, perfluoroalcohol phosphate/polysiloxane mixture, perfluoroalcohol phosphate/acrylate silicone copolymer mixture, tetrafluoroethylene/hexafluoropropylene copolymer (FEP), polytetrafluoroethylene (Teflon), polyxylene (Parylene), fluorinated polyhedral oligomeric silsequioxanes, or combinations thereof.

3. The method of claim 1 wherein the plurality of particles comprises sand, bauxite, sintered bauxite, silica alumina, glass beads, ceramic materials, glass materials, polymer materials, polytetrafluoroethylene materials, nut shell pieces, seed shell pieces, fruit pit pieces, wood, composite particulates, gravel, or combinations thereof.

4. The method of claim 1 wherein the plurality of particles are partially coated with the amphiphobic compound.

5. The method of claim 1 wherein the carrier fluid comprises aqueous gels, foams or emulsions.

6. The method of claim 1 wherein the slurry comprises a concentration of amphiphobic proppants ranging from about 0.05 to about 1.25.

7. The method of claim 1 wherein the amphiphobic proppants comprise more than one coating.

8. The method of claim 1 wherein the amphiphobic proppants have a water repellency as measured by contact angle of 90 degrees or more.

9. The method of claim 1 wherein the amphiphobic proppants having a mineral oil repellency as measured by contact angle of 90 degrees or more.

10. The method of claim 1 wherein the plurality of particles are ellipsoidal, platelet-shaped, toroidal, oblate spheroids, prolate spheroids, scalene spheroids, rod-like, or combinations thereof.

11. The method of claim 1 wherein the amphiphobic coating comprises more than one compound.

12. The method of claim 11 wherein the one or more compounds comprises at least a hydrophobic compound and an oleophobic compound.

13. A method of fracturing a subterranean formation comprising:
a) providing amphiphobic proppants made from one or more amphiphobic compounds;
b) mixing the amphiphobic proppants with a carrier fluid to form a slurry; and
c) introducing the slurry into the subterranean formation to open a fracture, wherein the amphiphobic proppants prevent build-up of fluid within the fracture and also enhance production of hydrocarbons with the fracture.

14. A proppant comprising:
a particulate substrate material; and
an amphiphobic coating at least partially covering said particulate substrate material.

15. The proppant of claim 14 wherein the particulate subtrate material comprises sand, bauxite, sintered bauxite, silica alumina, glass beads, ceramic materials, glass materials, polymer materials, polytetrafluoroethylene materials, nut shell pieces, seed shell pieces, fruit pit pieces, wood, composite particulates, proppant particulates, gravel, or combinations thereof.

16. The proppant of claim 14 wherein the amphiphobic coating comprises silicon dioxide solvated in ethanol or other solvents, organo-siloxanes, fluoropolymers, fluorinated compounds, tetrafluoroethylene/(perfluoroalkyl) vinyl ether copolymer (PFA), polyfluoroalkylethyl methacrylate/alkylmethacrylate copolymer, perfluoroalcohol phosphate, perfluoroalcohol phosphate/polysiloxane mixture, perfluoroalcohol phosphate/acrylate silicone copolymer mixture, tetrafluoroethylene/hexafluoropropylene copolymer (FEP), polytetrafluoroethylene (Teflon), polyxylene (Parylene), fluorinated polyhedral oligomeric silsequioxanes, or combinations thereof.

17. The proppant of claim 14 wherein the amphiphobic coating comprises more than one compound.

18. The proppant of claim 17 wherein the more than on compound comprises a hydrophobic compound and a lipophobic compound.
